(19) United States
(12) Patent Application Publication
(10) Pub. No.: US 2018/0089665 A1
(43) Pub. Date: Mar. 29, 2018

(54) GIFT CARD MANAGEMENT SYSTEM

(71) Applicant: ATG Properties, LLC, Salem, OR (US)

(72) Inventor: Christopher Alan Wright, Molalla, OR (US)

(73) Assignee: ATG Properties, LLC, Salem, OR (US)

(21) Appl. No.: 15/721,468

(22) Filed: Sep. 29, 2017

Related U.S. Application Data
(60) Provisional application No. 62/401,548, filed on Sep. 29, 2016.
(60) Provisional application No. 62/541,031, filed on Aug. 3, 2017.

(51) Int. Cl. G06Q 20/34; G06Q 20/40

(52) U.S. Cl. CPC G06Q 20/348; G06Q 20/4016

(57) ABSTRACT

A gift card management system may include a plurality of software modules configured to facilitate the efficient, secure purchase and resale of gift cards, as well as provide comprehensive tracking of gift card status throughout the process. In some examples, the gift card management system may include risk level analysis, e.g., based on historical data. This risk level analysis may facilitate risk-related actions (e.g., automatic transaction prevention) and dynamic risk level indication in a user interface for alerting users.

### CROSS-REFERENCES

This application claims the benefit under 35 U.S.C. § 119(e) of the priority of U.S. Provisional Patent Application Ser. No. 62/401,548, filed Sep. 29, 2016, and U.S. Provisional Patent Application Ser. No. 62/541,031, filed Aug. 3, 2017, the entireties of which are hereby incorporated by reference for all purposes.

### INTRODUCTION

Gift cards are commonly bought from merchants and given as presents or as a way of controlling purchases, e.g., by a child. Merchandise credit cards may be issued by retailers as a way to refund customers that wish to return merchandise but do not have a receipt (i.e., proof of purchase). These gift cards and merchandise credit cards may be bought and sold by individuals and businesses after their initial purchase/issue from a merchant. For example, third party vendors exist online to purchase such cards for less than the balance on the card. These vendors then resell the cards to other individuals for a higher amount, still less than the balance on the card, and obtain a profit in the process. Other businesses, such as those having brick-and-mortar locations, may also participate in this market, and may also interact with the online vendors. Such participation is typically ad hoc, unorganized, and inefficient. Additionally, new participants in the market are particularly susceptible to high loss rate due to fraud in the industry. Accordingly, a need exists for locally-usable software and methods to manage and facilitate the execution of gift card purchasing and resale transactions.

### SUMMARY

The present disclosure provides systems, apparatuses, and methods relating to gift card management systems. In some embodiments a gift card management system includes: one or more processors; a memory; a plurality of instructions stored in the memory and executable by the one or more processors to: receive and store information relating to a gift card, the information including brand identifier, monetary value, and selling customer; present a user, via a user interface, with information relating to a transaction history of the selling customer; in response to a first user input, record a transaction including a purchase of the gift card by the user from the selling customer; assign a first status to the gift card; in response to a second user input, list the gift card for sale and assign a second status to the gift card; in response to a third user input, flag the gift card as failed due to devaluation after purchase, and assign a third status to the gift card; in response to a fourth user input, transfer ownership of the gift card to a resale purchaser, and assign a fourth status to the gift card; interface with a data store to aggregate data relating to the purchase and sale of the gift card with data from other transactions regarding other gift cards.

In some embodiments, a computer-implemented method for displaying risk information relating to and facilitating the purchase of one or more gift cards may include: receiving, via a graphical user interface (GUI) of a computer-implemented gift card management system, entered information relating to a gift card being presented from a customer for purchase by a user, the entered information comprising a brand identifier and a monetary value; and in response to receiving the brand identifier and the monetary value, dynamically displaying a risk level indicator via the GUI on a same screen as the entered information, the risk level indicator corresponding to an estimated probability of failure of the gift card being purchased; wherein the risk level indicator represents a risk level based on a combination of factors comprising a first factor corresponding to historical failure data related to the brand identifier and a second factor corresponding to historical failure data related to the monetary value, the factors being weighted by respective coefficients selected by the user.

In some embodiments, a computer-implemented method for reselling a gift card may include: receiving, by a computer-implemented gift card management system, an entered first set of information relating to a gift card being presented from a selling customer for purchase by a user, the first set of information including a brand identifier and a monetary value; retrieving, from a data store of the system, a second set of information relating to a plurality of gift card-purchasing vendors and a third set of information relating to a gift card resale market; based on the first, second, and third sets of information, calculating a return on investment (ROI) for each of the plurality of vendors; determining which vendor of the plurality of vendors has a largest ROI, and identifying the vendor with the largest ROI as a preferred vendor; dynamically notifying the user, via the gift card management system, of the preferred vendor; and in response to at least one command received via the gift card management system, transferring ownership of the card to the user and listing the gift card for sale with the preferred vendor.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative gift card management system in accordance with aspects of the present disclosure.

FIG. 2 is a schematic diagram of an illustrative card management program suitable for use in a gift card management system according to the present teachings.

FIG. 3 is a schematic diagram of an illustrative card and transaction risk assessment system in accordance with aspects of the present disclosure.

FIG. 4 is an illustrative graphical user interface (GUI) having an illustrative risk indicator.

FIG. 5 is another illustrative GUI having additional examples of risk indicators.

FIG. 6 is a flow chart depicting steps in an illustrative method for using a gift card management according to the present teachings.

FIG. 7 is a flow chart depicting steps in another illustrative method for using a gift card management according to the present teachings.

FIG. 8 is a flow chart depicting steps in an illustrative method involving the purchase of gift cards from a selling customer.

FIG. 9 is a flow chart depicting steps in an illustrative method involving the reselling of gift cards to a vendor.

FIG. 10 is a flow chart depicting steps in an illustrative method involving the reselling of gift cards to other customers.

FIG. 11 is a flow chart depicting steps in an illustrative method involving post-sale activities, such as report generation.

FIG. 12 is a schematic diagram of an illustrative data processing system.

FIG. 13 is a schematic diagram of an illustrative distributed data processing system or network.

### DESCRIPTION

Various aspects and examples of a gift card management system having card and customer tracking features, as well as related systems and methods, are described below and illustrated in the associated drawings. Unless otherwise specified, a gift card management system according to the present teachings and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“Coupled” means connected, either permanently or releasably, whether directly or indirectly through intervening components, and is not necessarily limited to physical connection(s).

### Overview

In general, a gift card management system in accordance with the present teachings may include a software program or programs, with associated business practices, configured to manage the initial purchase and resale of stored-value money cards, i.e., gift cards (also referred to as gift certificates, gift vouchers, or gift tokens) and/or merchant-issued merchandise credit, collectively referred to hereinafter as “gift cards.” Gift cards typically have a form factor and functionality similar to credit cards, and may be issued by retailers, banks, and the like, to be used (usually anonymously) as a substitute for cash, usually at a particular retailer or establishment. For example, gift cards may be purchased at a retailer or third party provider for use at businesses such as Kroger, Target, Home Depot, etc., as well as online sellers such as Amazon and iTunes, among many others. These gift cards may be resold by customers, e.g., to each other, to an online resale website (such as raise.com or giftcardbin.com), on craigslist, on ebay, or to businesses such as gift card specialty stores, check cashing stores, major retailers like Safeway or Walmart, pawn shops, mobile phone stores, or payday lending companies. This sort of resale typically involves selling the card for less than its face value, such that the purchaser can make a profit from the transaction, either by using the card or reselling it to another party.

Gift card management systems according to the present disclosure are configured to manage and facilitate the processes involved in the gift card resale market. Such systems and methods may be used, for example, by a local business or a chain of businesses to keep track of multiple customers, cards, and transactions, as well as to handle accounting and risk management aspects of the business, in some cases across multiple locations.

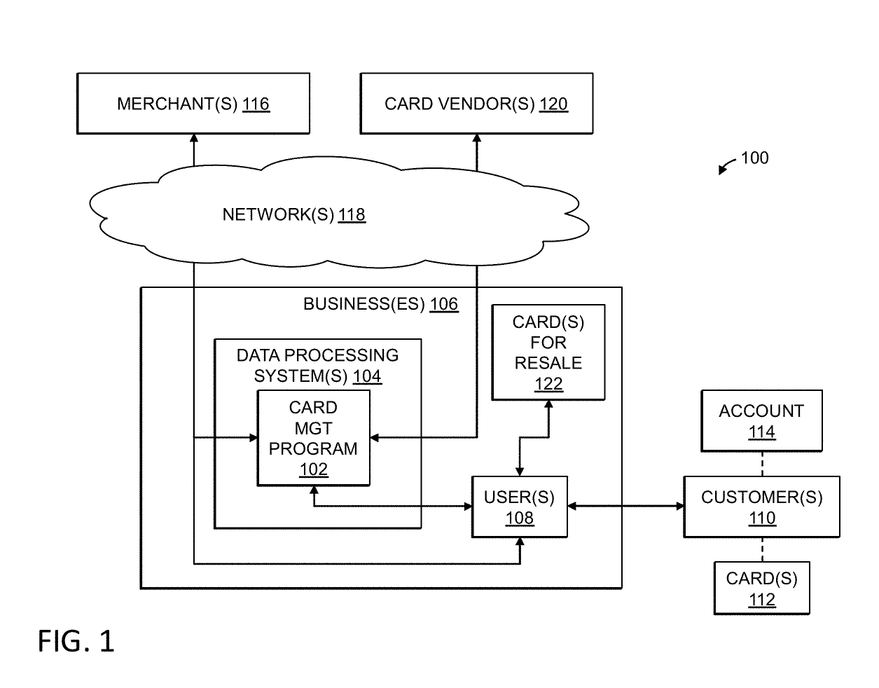

With reference to FIG. 1, an illustrative gift card management system is generally indicated at 100. System 100 may include a card management program 102 installed on a data processing system 104 (see Data Processing System description below) at a business 106. Business 106 may include a so-called brick and mortar business, i.e., a physical location. A user 108 may administer the system, and may include an employee, owner, or agent of business 106.

One or more customers 110 may interact with business 106, e.g., via user 108, to effect the purchase and/or resale of gift card(s) 112 to the business. For accounting and risk management purposes, each such customer may be assigned an account 114 in system 100 (e.g., in card management program 102). As part of the sale of cards 112 to business 106, user 108 may confirm or verify the balance on the card(s) by communicating with a respective merchant 116 associated with each card. Such communication may be carried out using card management program 102, or in any other suitable fashion, and may be done via a computer network 118, such as the Internet. Note that more than one business 106 may be in communication with network 118, thereby creating a network of such businesses. This network arrangement may result in or enhance additional features and benefits outlined below.

Cards 112, once purchased by the business, may be tracked using card management program 102. Based on the preference of the user/business, each card 112 may be resold to a third party card vendor 120 (e.g., a card resale website, such as raise.com, cardpool.com, or the like), resold on an affiliated network of program users, or made available for sale to other customers at the business, as indicated at 122. Reselling to online card vendors or through an affiliated network may include communicating via the vendor's application programming interface (API), direct integration of system and vendor or affiliated network, and/or transferring data files, e.g., comma-separated value (CSV) files.

Card management program 102 may include any suitable software and/or hardware modules or components configured to carry out the functions described herein. Additional details regarding aspects of program 102 are provided below, as well as in the attached Appendices.

Aspects of gift card management systems according to the present teachings may be embodied as a computer method, computer system, or computer program product. Accordingly, aspects of the gift card management system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the gift card management system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device. Such a computer-readable storage medium may be local to the user or computing device, or may be distributed on a network. In some examples, the computer-readable storage medium may be provided by a third party service, such as a so-called cloud platform (e.g., Amazon Web Services or Microsoft Azure).

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the gift card management system may be written in one or any combination of programming languages, including an object-oriented programming language such as Java, Smalltalk, C++, and/or the like, and conventional procedural programming languages, such as C. Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the gift card management system are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided (including locally and/or remotely) to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the gift card management system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### EXAMPLES, COMPONENTS, AND ALTERNATIVES

The following sections describe selected aspects of exemplary gift card management systems as well as related systems and/or methods. The examples in these sections are intended for illustration and should not be interpreted as limiting the entire scope of the present disclosure. Each section may include one or more distinct embodiments or examples, and/or contextual or related information, function, and/or structure.

### A. Illustrative Card Management Program

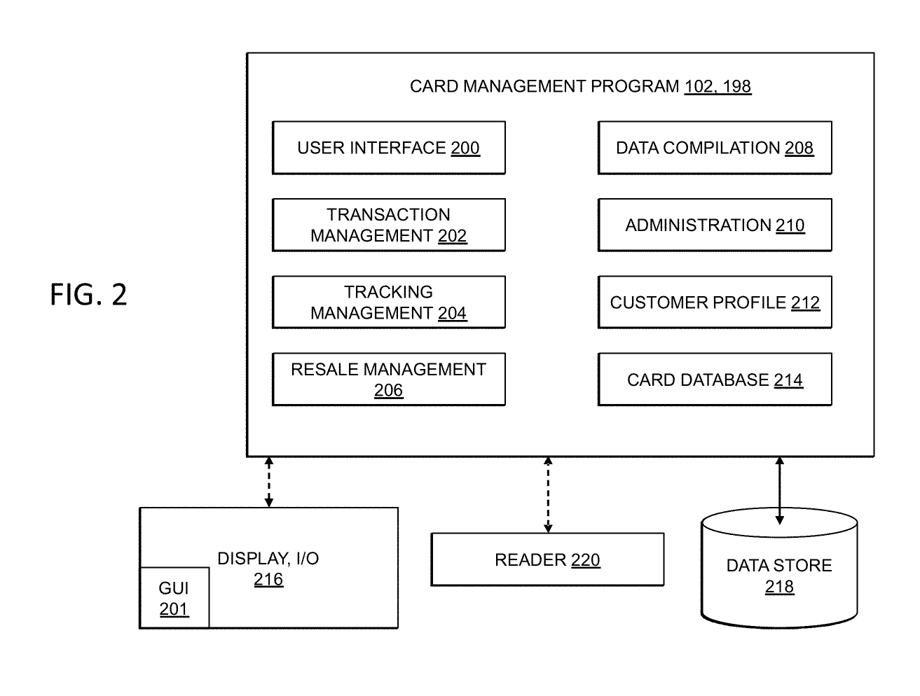

As shown in FIG. 2, this section describes an illustrative embodiment of gift card management program 102 (described above), generally indicated at 198.

Program 198 may include any suitable instructions and code executable by a processor to carry out the functions and algorithms described below. In some examples, program 198 may include more or fewer modules than those described in this section. As shown in the example of FIG. 2, program 198 may include a user interface module 200, a transaction management module 202, a tracking management module 204, a resale management module 206, a data compilation module 208, an administration module 210, a customer profile module 212, and/or a card database module 214. These modules may overlap or be combined in actual implementation. However, their functionality is described modularly here for ease of explanation.

User interface module 200 may include any suitable instructions configured to provide a human readable interface 201 (e.g., a graphical user interface or GUI) facilitating user interaction with aspects of program 198. UI module 200 may cause the display of graphics, displays, icons, text, animations, tables, etc. on GUI 201, and a user may interact using a keyboard, mouse, touch screen, voice command, motion controls, and/or the like, or any combination of these. For example, UI module 200 may communicate with a display screen 210 (e.g., a computer monitor or portable device screen). Examples and features of an illustrative GUI are described further below (see Section B).

Transaction management module 202 may include any suitable instructions configured to provide card settings, risk assessment and modification, automatic card balance checkers, error checking, annotation, account information, editing, and/or other management functionality for the program.

A card settings feature of module 202 may facilitate more efficient transaction management. The card settings feature may include: accepted brands for purchase, a fixed (e.g., manager overridable) brand-specific percentage payout to customer (e.g., based on value of card), and/or individual card min/max value limits. Brand-specific settings can be manually and individually set or adjusted/set in bulk, e.g., with a spreadsheet upload feature.

A risk assessment and modification feature of module 202 may facilitate decision-making and predictive or proactive indication of risk factors, including those not otherwise visible to the user. The risk assessment and modification feature may include any suitable instructions configured to analyze and/or adjust the risk associated with a selected card, customer, and/or other aspect of the system. For example, a variable risk level may be associated with each customer account, with the risk level being modified as the customer executes transactions, and is found to be either reliable or problematic with respect to gift card transactions. Risk assessment and modification may be included in program 198 to track and modify such a customer risk level, using one or more algorithms. Additionally or alternatively, risk assessment and modification may track and/or determine a risk level associated with a given card or merchant. For example, certain cards may utilize personal identification numbers (PINs) that are hidden until revealed by the customer (e.g., using a scratch-off covering). Cards having such a feature, or the like, may be lower-risk than cards that do not have the PIN feature. Individual cards may have risk factors as well, such as the balance (higher balance may be higher risk), the condition of the card, whether the card comes in certain original packaging, the age of the card (if known), etc. Certain merchants may also have systems or procedures in place that make fraud less likely, causing cards for those merchants to be lower risk for the user/business purchasing them from a customer.

Various such factors may be utilized to associate a risk level with a customer, a card, and/or a merchant. In one example, a risk level algorithm may gradually allow a customer to sell more cards based on repeat business. As the customer comes in more, their daily, weekly, and/or monthly limit may increase. Additionally or alternatively, the maximum allowable individual values of each card may increase. Levels may include a low, medium, and high risk. Additional details of illustrative risk algorithms are included below in Section B.

In some examples, the user can set limits, e.g., for each card brand based on customer history, brand of card, and type of card. User-set limits may include min/max individual value of card(s), number of cards, and/or aggregate value limit of all cards per transaction, day, week, month (e.g., 30 day rolling cycle), and/or year.

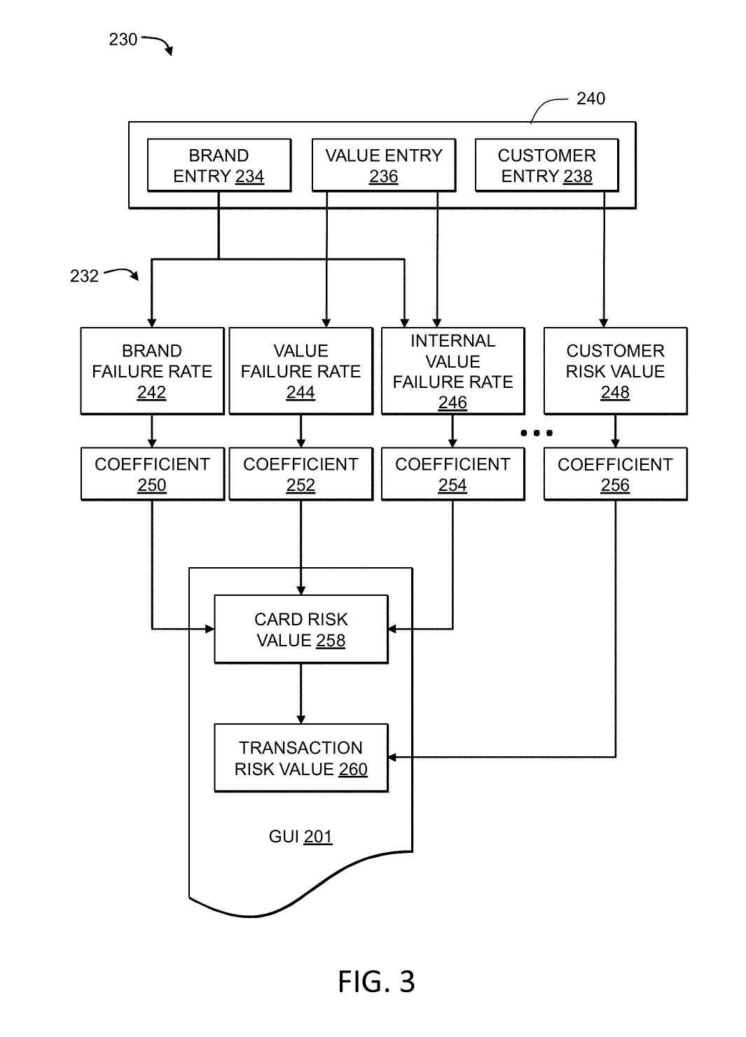

As shown in FIG. 2, program 198 and module 202 may interact with and modify the data stored in a data store 218. Data store 218 may include any suitable data store(s), such as a relational database or hierarchical database, configured to store and respond to queries regarding customer, user, card, and/or transactional records. Selected methods that may be executed by module 202 are described below, regarding FIGS. 3-11. Certain aspects of transaction management may be facilitated or enhanced by, for example, including a reading device 220 for inputting information into the system. Reading device 220 may include a barcode scanner, a camera or imaging device, a webcam, a sensor, an RFID reader, a magnetic strip reader, a chip reader, and/or the like, or any combination of these. For example, reader 220 may include a digital camera and software configured to optically recognize card numbers, PIN information, etc. In some examples, a photo or scan of the card may be stored in data store 218 and associated with the card record.

A tracking management module 204 may include any suitable instructions configured to provide the tracking of cards (e.g., end-to-end) with multiple vendors through a progression of statuses (e.g., from purchased to resold). These statuses usually progress or change in a linear fashion to a final end status (e.g., sold). The final end status can change over time (e.g., devalued, balance discrepancy), and an intermediate status may be assigned (e.g., review). The card status tracking process may link the system user information to third party information. This process can be manual, semi-automatic (i.e., having manual and automatic features), automatic, or any combination of these.

A manual method may include a manual upload of system information to third party vendor sites. A subsequent gathering of information from the third party sources may be manually input into the gift card management system to change the gift card statuses and/or customer profiles.

A semi-automatic process may involve a spreadsheet (.csv, .xls, .xlsx, etc. file formats) upload of information to third party vendor sites (if vendor is capable) with a subsequent spreadsheet download of third party information and upload to gift card management system 100. System 100 processes the uploaded third party information using module 204, and changes the gift card statuses and/or customer profiles. This process can vary with a spreadsheet upload to vendor sites and subsequent manual change of system statuses and/or customer profiles (or vice versa), manual upload of system information to third party vendor sites followed by a spreadsheet download from third party sites and upload to the system.

An automatic process may involve an API and/or direct integrated communication with third party vendors or affiliated networks. System information is continually transmitted and received in real- or near real-time to vendor(s) or an affiliated network. Gift card statuses and customer profiles are subsequently updated.

A data compilation module 208 may include reporting and output, as well as data sharing capabilities. The reporting and output feature may include any suitable instructions configured to provide informational, summary, financial, transactional, archival, and/or other reports to a user based on the records in data store 218. For example, a sorted list of customers over a specified period of time may be printed or shown on a screen. The system may be configured to calculate profit, loss, etc., based on the sales price of the card from the vendor's website. The system may compare the amount invested in the card (i.e., payout to the selling customer) against the price sold, minus any loss, to calculate profit, loss, return on investment (ROI), etc.

A resale management module 206 may include any suitable instructions configured to facilitate the reselling of gift cards through a storefront application, single and multiple online vendors, an affiliated network of gift card management users, or any combination thereof. The resale management module includes an algorithm and manual selection capability that determines where to resell gift cards (online vendor or multiple vendors, storefront, affiliated network of gift card management users) based on the greatest ROI.

In some examples, a resale management module algorithm of module 206 may include the following scenario: A user business wishes to get the highest return on investment for brand X of gift card. In the card settings section of card management program 198, the user can select where to resell brand X. These choices are as follows: resell to any vendor the user currently does business with, resell in storefront, resell on affiliated network, or a highest-ROI algorithm. If the highest-ROI algorithm is selected, the program will designate brand X to be resold to the venue that gives the highest return on investment (i.e., highest resale value). This can frequently change as resale values fluctuate in the market. Accordingly, a timeframe or deadline or designated date may be specified by the user as to when the algorithm should conduct and/or terminate its search for the best ROI.

Gift cards listed for sale within a storefront location may be primarily purchased by the storefront or acquired from other sources (e.g., purchased from online vendors, selling online vendor's inventory through storefront on behalf of online vendor, purchasing from other gift card management system subscribers, or selling gift card management system subscriber's inventory through storefront on behalf of gift card management system subscribers). For risk assessment, loss mitigation, and data compilation purposes, cards for sale in a storefront application will each have a profile that associates the original selling customer with the recent purchasing customer.

An administration module 210 may include any suitable instructions configured to facilitate the editing, creation, or updating of user settings, customer accounts, etc., associated with the program. For example, passwords may be set and reset, customer accounts may be created and updated, user permissions may be determined, etc.

A customer profile module 212 may include any suitable instructions configured to facilitate the capture, storage, and organization of customer transaction data. This information may be used in conjunction with other program modules. For example, during an initial purchase process, transaction management module 202 may use information of customer profile module 212 to accomplish risk analysis. Once purchased, the card record may be retained in the card database with corresponding customer data. After the resale phase, resold cards may retain initial selling and purchasing customer/vendor data. This customer data may then be used in conjunction with data compilation module 208 for reporting and data sharing.

Card database module 214 may include any suitable instructions configured to facilitate the capture and storage of card data. This information may be used in conjunction with other program modules. During the initial purchase process, the transaction management module may use card profile data for risk analysis and card min-max limitations (e.g., user defined). Once purchased, the card record is retained in the card database. During the storefront resell process, cards marked for storefront resell are inventoried as available for purchasing customers. Once sold, card records may retain initial selling and purchasing customer/vendor data. This card data may be used in conjunction with data compilation module 208 for reporting and data sharing.

### B. Illustrative Risk Management Methods and Associated Screen Displays

As shown in FIGS. 3-5, this section describes various aspects of risk assessment, risk adjustment, risk display, and/or risk level determination with respect to the card management system (e.g., with respect to the risk assessment and modification feature of module 202). The descriptions below are illustrative in nature, and not intended to limit the possible ways a risk assessment module may be implemented.

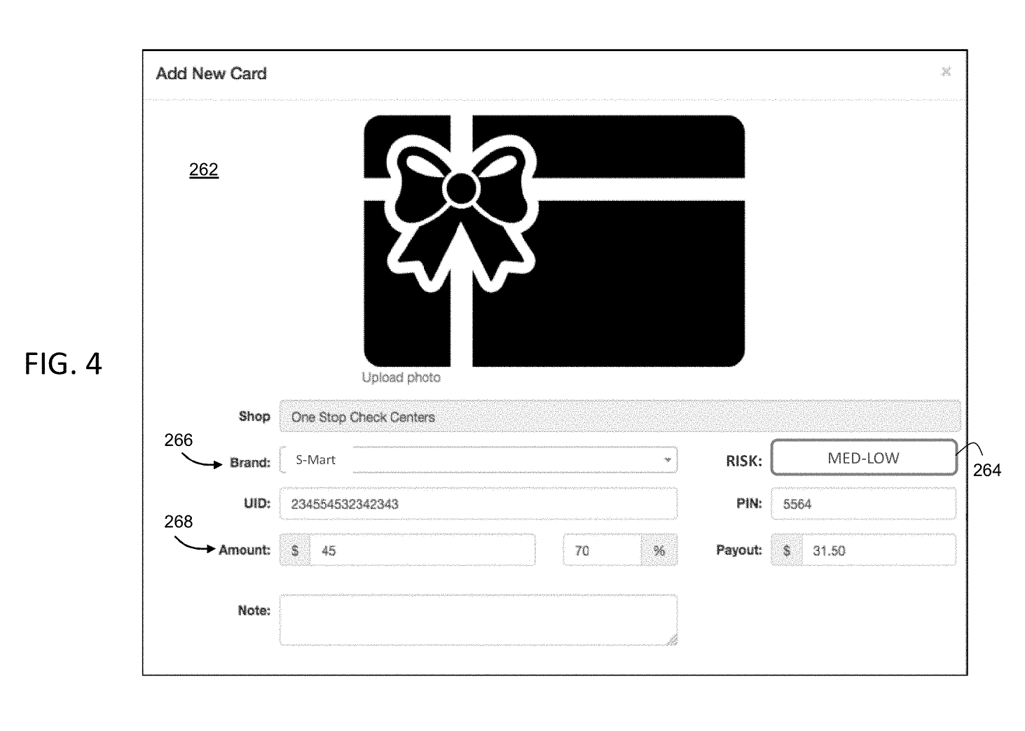

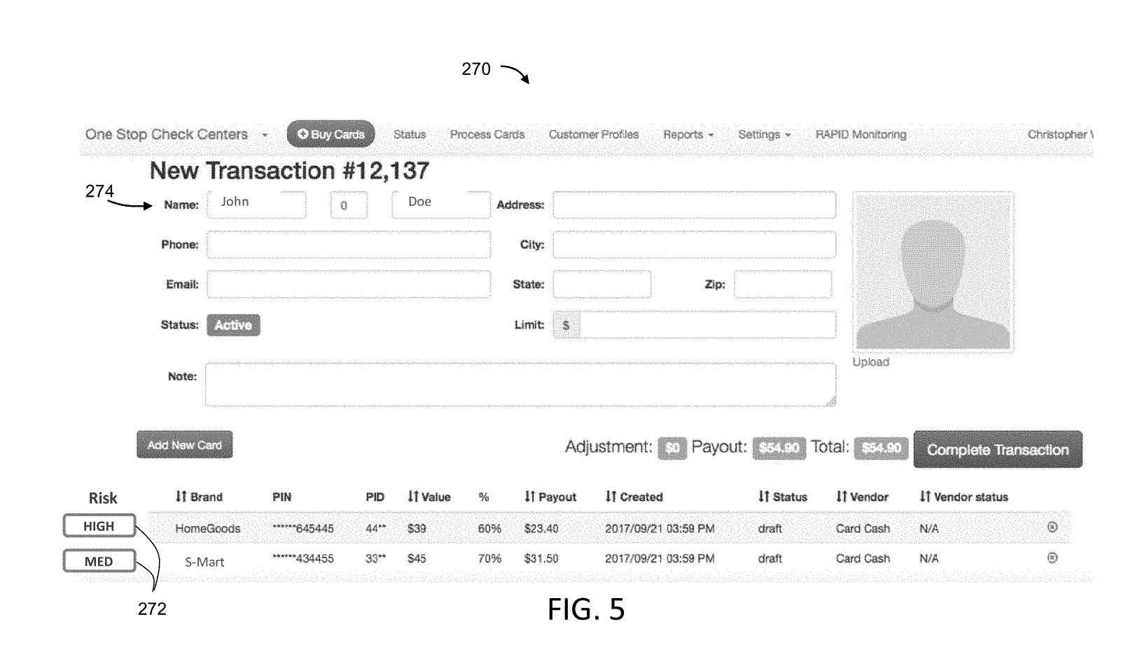

FIG. 3 is a schematic diagram of an illustrative system 230 for dynamically determining and displaying a risk value associated with a gift card and/or a transaction. FIGS. 4 and 5 are examples of graphical user interfaces (GUIs) suitable for use with system 100 and including display elements configured to dynamically show a risk value to the user.

Because of fraud, gift card buying and selling businesses can sustain significant losses from devalued or faulty cards. Moreover, fraud is often associated with a particular card vendor or customer. Thus, preventing loss due to fraud by avoiding risky cards or customers can give a gift card buying and selling business a significant advantage over other businesses. One way to prevent fraud is to avoid cards and/or customers who have an unacceptably high risk. As such, a system user conducting a gift card transaction is required to make a quick and strategic decision as to whether or not to purchase a particular card from a particular customer. Existing approaches to making this decision rely on complicated look-up methods and/or employee recall of significant amounts of information about a particular brand, card value, customer, and/or other features of a transaction to make a sound purchasing decision. Risk determination methods and associated GUIs taught herein solve the problem by dynamically providing the user with up-to-date, aggregated, risk information in a fast, reliable manner. The graphical user interface makes the decision-making process easier and faster by automatically collecting and/or processing information and presenting it to the user in an easy-to-understand display (see examples below). Furthermore, the methods and GUI displays described herein enable enhanced automatic decision-making, such as error-proofing via cut-off limits and risk-associated transaction prevention. This gives the user a significant advantage over users without the systems and methods described herein.

The configuration of the screen display itself informs the user (such as an employee, manager, and/or owner) in a faster and more efficient manner than existing gift card organization systems. Users gain a significant advantage by immediately and automatically seeing a visual risk indicator corresponding to a particular seller or card, because the user can be instantly alerted to risk and even to early trends, e.g., with particular vendors, using information from across the network. In other words, the experiences of multiple businesses can be harnessed and summarized, eliminating guesswork and inconsistency. Moreover, the risk indicator display element is presented in close proximity to other information relating to the card and seller, in a real-time, nonintrusive manner that is easily viewable during a standard transaction. This kind of information would otherwise take days or weeks to reach the user, e.g., through conventional means or existing localized systems. Accordingly, the risk determination method and screen display system facilitates a more consistent, faster, and less error-prone decision during a card purchase transaction.

Without the risk indication display and associated risk management algorithms, no such strategies would be possible in the timeframe necessary. Without the risk determination methods and visual risk indicator, the user is forced to rely on slower methods and decentralized records. As such, the user would be unable to make fully informed decisions within the constrained timeframe of a transaction with a customer. Without the risk management algorithms in particular, a user would have to manually investigate each card or card type and would be slower, or even unable, to avoid risky cards or customers, therefore likely sustaining higher losses. Without the organization provided by this interface and the risk management algorithms, a user would be slower to notice trends in gift cards sales and thus to predict which brands or cards may soon become less reliable.

Turning to FIG. 3, system 230 (also referred to as an algorithm) is an example of a risk analysis and display system that may be integrated into system 100, e.g., in transaction management module 202. As an initial matter, historical data is collected for all card transactions, both at the local store level and in the aggregate, e.g., by the entity providing system 100 as a SaaS product. For example, card database 214 and data store 218 may contain a significant amount of up-to-date historical information relating to cards and seller-customers. Additionally, in some examples, problem cards or customers may be reported manually via the system, flagging those cards or customers for additional analysis. For example, a customer who sold a card that is later found to have a balance discrepancy could be reported (also referred to as being “published”) as a “risk customer.”

The risk control algorithm of system 100 receives notices of risk customers, and aggregates the card data from all failed cards. In some examples, the risk control algorithm ranks different card features from least to most risk. This ranking is updated with each new failed card submitted to the risk control algorithm. Based on the aggregated information from this algorithm, rankings or risk values relating to multiple failure factors (components) are maintained. A set of such failure factors 232 may then be used to obtain an estimate of the probability of failure for a card presented for sale by a selling customer.

As depicted in FIG. 3, when a card is entered into system 100 during a transaction, a brand name 234, a face value 236 of the card, and customer identifying information 238 are entered into the system during a data entry phase 240. This data is used to look up a brand failure rate 242, based on a historical rate of failure of all cards from that vendor or brand name, a value failure rate 244, based on a historical rate of failure of all cards having that face value (actual or within selected ranges), and an internal brand value failure rate 246, which is the failure rate for that value within that particular brand only. Failure rates may be calculated using any suitable method. For example, one or more of the failure rates may be calculated for a specific time frame (e.g., past month) or for the entire history, or may be weighted more or less heavily based on how recent the failures are (e.g., heavier weight on failures within the past week). The customer data is also used by the system, to look up the customer-specific risk value 248. This risk value may be determined by any suitable method, using any suitable factors, such as length of relationship, number of transactions, failure rate of customer's transactions, average value of cards sold, and/or the like, or any combination of these.

As indicated in FIG. 3, different or additional card risk factors may be utilized, and are anticipated by the present disclosure. For example, a geographical failure rate may be utilized, as the networked system recognizes higher or lower failure rates by geographical region.

Regardless of the number or type of factors used, the risk factors are each given a coefficient or weight, by which the failure rates and customer risk value are multiplied to provide one or more combined risk values. In the example of FIG. 3, the failure rates and customer risk value are given coefficients 250, 252, 254, and 256, respectively. As shown in the examples below, each coefficient may comprise a percentage, a factor, a decimal number, or any other weight value. In some examples, the coefficients are distributed as desired by the user but are required to add to a specified total (e.g., 1.0, or 100). In some examples, the coefficients are not so constrained, and any value may be used. In any event, the failure rates are modified by their respective coefficients and summed together to reach a risk value. Taking the known coefficient and risk value information constraints into account (e.g., typical ranges, units, etc.), the summarized risk value can then be either displayed directly or categorized. For example, if the outcome is known to be a number from 1 to 100, then a risk value of 1 to 10 may be categorized as a “low” risk, while a “high” risk may, e.g., be defined as anything over 40.

One having skill in the art will also recognize that the risk factors and coefficients comprise a matrix that may be suitable for machine learning methods, such as using a trained neural network (supervised or unsupervised) to determine proper weights, to determine suitable categories of risk, etc. Such machine learning methods are within the scope of the present disclosure. However, the examples herein are described in the circumstance where the coefficients are selected manually, based on user preference. In some examples, the risk factors may also be selectable.

As shown in FIG. 3, a card-specific risk value 258 is determined based on card-specific data and coefficients. In other words, card risk value 258 is independent of the selling customer. Customer risk value 248 and its coefficient 256 may be taken into account, e.g., in combination with factors 242, 244, 246 or in combination with the resulting card risk value 258, to modify the card-specific risk based on the customer presenting the card for sale. In some examples, this modification of the card risk is a simple combination of all failure factors 232, including customer risk value 248, resulting in a transaction risk value 260. Transaction risk value 260 may also be categorized, as described above with respect to card risk value 258. In some examples, modification of the card risk includes further rules, such as a directional prohibition, e.g., the customer risk value may only modify the card risk value in a more-risky direction. In other words, in those examples, the card risk value is a floor, such that when taking the customer into account, the transaction may be assessed to be riskier, but it will not be assessed to be less risky.

In some examples, one or more failure factors and/or risk values may be manually overridden as desired by the user.

To provide functional benefits and maximum impact, as shown in the examples of FIGS. 4 and 5, card risk value 258 and/or transaction risk value 260 may be displayed on graphical user interface (GUI) 201. GUI 201 is also referred to as a screen display.

FIG. 4 depicts an illustrative GUI 262 of system 100, which is a first example of GUI 201, showing a screen display including a card risk indication element 264 (also referred to as a risk indicator or a risk level indicator). GUI 262 is an illustrative screen display that is presented to the user during operation, when the user wishes to enter a new card to be considered for purchase from a customer who has, e.g., entered the user's store. GUI 262 comprises a data entry screen for the card in question, including a first interface element 266 for entering or selecting the brand and a second interface element 268 for entering or selecting the card's face value or amount, among others. In response to entry of the brand and value in the first and second interface elements, system 100 (e.g., modules 200, 202) causes risk indication element 264 to populate and/or appear, displaying a risk indication to the user based on the card brand and card value. As described with respect to FIG. 3, this may be a category or a value, and is based on card-specific risk values that are kept up to date, e.g., based on aggregated failure information from across the network. In the example depicted in FIG. 2, the risk indicator is relative to the card and has not yet been modified by customer risk. In some examples, GUI 262 may take customer identification into account and, alternatively or additionally, present a transaction risk indicator. Risk indicator 264 may include any suitable indicia and have any suitable appearance, including color, shape, text, font, and/or the like.

FIG. 5 depicts another illustrative GUI 270, which is a second example of GUI 201, showing a transaction screen display including transaction risk indication elements 272 (also referred to as risk indicators or risk level indicators). GUI 270 is an illustrative screen display that is presented to the user during operation, when the user wishes to enter a customer's information and the one or more cards that customer wishes to sell in the present transaction(s). Here, the user enters the customer's first and last name in a third interface element 274. In response to this entry, as well as possibly other identifying data related to the customer, system 100 automatically looks up the customer's risk value based on a selected number of factors, such as failure history, frequency of visits, tenure, etc. As described with respect to FIG. 3, this customer risk value is factored in with the card-based failure factors and a transaction risk value is determined, based on historical data across one or more systems 100 in the network. As shown in FIG. 5, each card (entered on GUI 262) has a transaction risk indication element 272 displayed adjacent to other card identifying data. Transaction risk indicator 272 may be the same as or different than card risk indicator 264, depending on the system set up.

Additional and/or alternative aspects of the risk control algorithm of system 100 will now be described. Each alternative may be combined with the aspects described above, in any suitable manner.

The risk algorithm may display gift card risk ranking information (e.g., risk level indicators) to users during the purchase phase. The ranking is based on probability of card failure, which is derived and continuously updated from card failure reporting. The ranking may be in categorical terms (e.g., low to high) and/or percentile based. The ranking may be based on all cards reported in the system, outside the system, or in combination, and corresponds to failure rates (i.e., card devaluation after purchase).

In some examples, a merchant (i.e., brand) risk factor may be determined and/or adjusted according to an algorithm. For example, a risk factor algorithm may determine a risk level based on (a) the card's face value (balance) in combination with (b) information regarding the known failure rate for cards associated with a specific brand or merchant. This known failure rate may be obtained from the user's own records, records of other users in a distributed network, and/or global records accumulated by an administrator of the overall card management system. For example, if the card management system is provided under a software-as-a-service (SaaS) model, the SaaS provider may aggregate card information across users, and provide sanitized and anonymized risk information to the users.

Brands may be ranked or ordered based on their failure rates, i.e., the percentage of cards that are devalued or unusable after purchase from the customer. Based on this ranking, which may change over time, risk categories may be determined, such as low/medium/high, or low/medium-low/medium-high/high, etc. For example, the best 20% of brands may be assigned a “low” risk, the worst 20% may be assigned a “high” risk, with the remaining 60% divided evenly between “medium low” and “medium high.” Other suitable rubrics may be utilized.

This risk level may then be adjusted by the balance on that particular card. For example, higher-balance cards may be higher risk. Accordingly, a low risk brand with a high balance may be bumped up to a medium risk level. The risk level may be displayed next to each card as it is entered into the system, for use by the user in determining whether to purchase the card from the customer (see, e.g., FIGS. 4 and 5). For example, an icon may be displayed. There may also be a user-, owner-, or manager-selectable filter that will forbid or prevent the purchase of cards based on risk factor, e.g., no cards purchased that are at the “medium high” ranking or above. There may also be a payout adjustment feature based on the risk level algorithm. This can be enabled or disabled by the user. For example, a “medium high” or above risk level may decrease the payout level by 10%.

In some examples, the customer risk level may be calculated and updated over time. For example, a customer risk level may be determined based on a plurality of factors, such as regularity of transactions, which brands the customer has sold, the face values of the cards the customer has sold, the frequency of visits to the business, behavior related to customer-purchased cards, and/or other reputation information relating to other types of transactions this customer has had with the user or other users. The customer's risk level may be used to set a limit on the maximum value of individual cards the customer can sell, and/or the maximum value over a period of time (e.g., week, month, year). Negative experiences, such as the customer selling devalued cards, may result in a higher risk level or an outright ban on selling. Users having multiple store locations may alert other locations to a user's fraudulent behavior.

In some examples, when a risk customer is published (i.e., a failed card is reported), the associated card data is sent to the risk control algorithm for processing. The risk control algorithm aggregates the card data from all failed cards and ranks different card features from least to most risk. This ranking is updated with each new failed card submitted to the risk control algorithm. Based on the information from this algorithm, multiple failure factors (components) are combined to give an overall risk component score and relating risk ranking for each new card.

In some examples (as described above), customer history may influence the overall (transactional) risk factor. For example, any new customer with a card over $100 may be considered high risk, $50-$75 may be considered medium risk, and under $50 may be considered low risk.

In some examples, a brand ranking system may include 100 brands available to purchase. Ranking 1 as the lowest brand to fail, and 100 as the highest brand to fail, the rankings may take the following form:
Low=Brands ranked 1 to 30
Medium=Brands ranked 30 to 70
High=Brands ranked 70 to 100
   A percentile ranking system may be determined by associating a percent failure rate a particular risk category. For example:
Low=2% of this brand fail
Medium=4% of this brand fail
High=7% of this brand fail
   Which percent failure corresponds with which ranking can be adjusted based on the card's value and on the customer's history. For example, if 10% of all Brand X fails, but 5% of this failure happens $0-$25, 30% happens $25-$50, and 30% happens $50 to $75, then a lower card value may have a lower risk ranking. Similarly, if 70% of that failure happens with a new customer, 10% happens with a customer from 2 to 5 visits, 10% happens from 5 to 15 visits, and 10% happens after 15 or more visits, then a card from a new customer may have a higher risk ranking. Other features may be included in the risk ranking algorithm and some features may be given more or less weight and/or importance by the algorithm. Features may be added, updated, and/or removed over time and the weight given to a particular feature may be adjusted based on different patterns of use, and/or the needs of a particular user.

### C. First Illustrative Method of Use

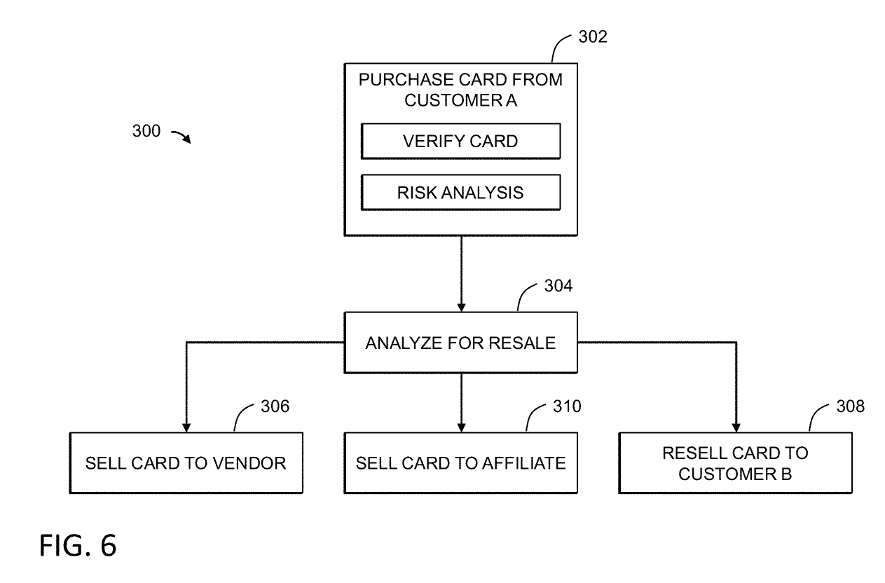

This section describes steps of an illustrative method for using a gift card management system (e.g., system 100); see FIGS. 6 and 8-11. Aspects of gift card management systems described above may be utilized in the method steps described below. Where appropriate, reference may be made to previously described components and systems that may be used in carrying out each step. These references are for illustration, and are not intended to limit the possible ways of carrying out any particular step of the method.

FIG. 6 is a flowchart illustrating steps performed in an illustrative method, and may not recite the complete process or all steps of the method. FIG. 6 depicts multiple steps of a method, generally indicated at 300, which may be performed in conjunction with gift card management systems according to aspects of the present disclosure. Although various steps of method 300 are described below and depicted in FIG. 6, the steps need not necessarily all be performed, and in some cases may be performed in a different order than the order shown.

At step 302, a user/business may purchase a gift card from a first customer. For example, customer A may enter an establishment having a gift card management system, and the agent at the establishment may purchase one or more cards from customer A, for a percentage of their face value. Step 302 may include verifying or confirming the face value of each card, e.g., by checking with the associated merchant's website. Communication may be performed using the card management program. Such verification, however, is not foolproof. For example, customer A may sell the card to the user, then immediately use the card's information to execute an online purchase. Accordingly, step 302 may further include a risk analysis, which may be performed by and/or using the card management program. This risk analysis may include characteristics of the customer, the card, the merchant, and/or other factors such as time of day or time of year. See discussion of risk management algorithms, above. (e.g., with respect to FIG. 3).

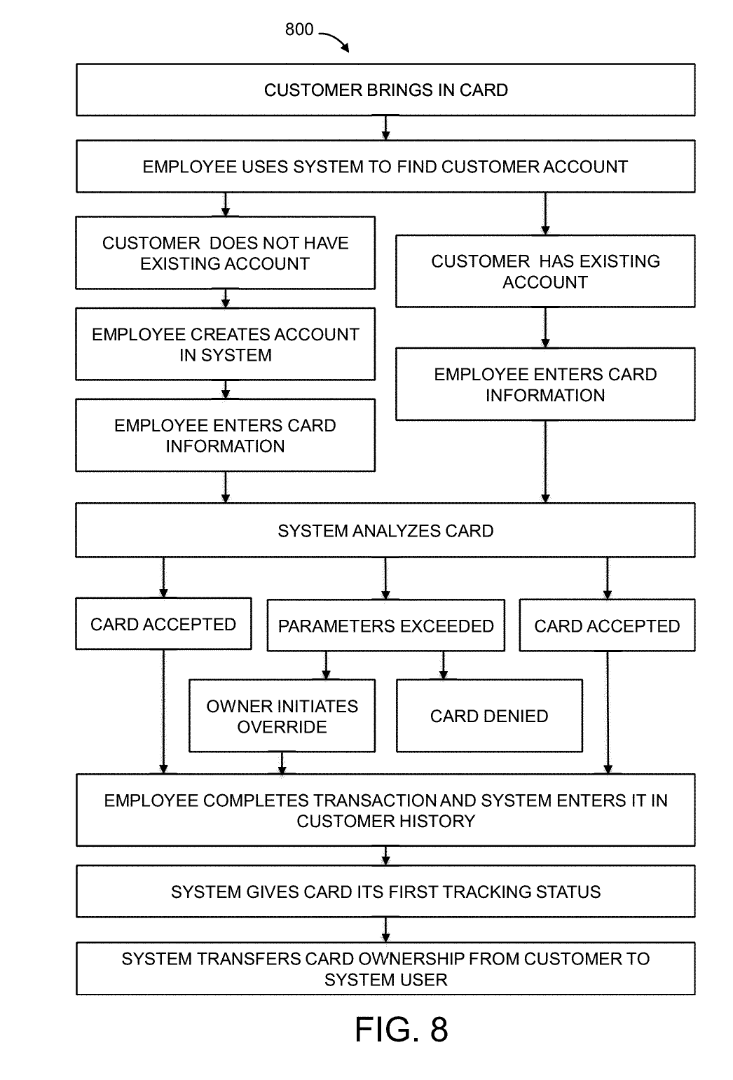

An illustrative method depicting steps of the purchasing process is generally indicated at 800 in FIG. 8.

Once the user has purchased the card, step 304 may include analyzing how the business should resell the card. Choices may include selling the card online to a third-party vendor (e.g., raise.com), or selling the card to another customer directly from the user/business. This analysis step may be performed by or with the assistance of the card management program. Analysis may include the assessment and weighing of factors such as card or vendor volatility, resale value, popularity, card features such as a scratch-off PIN, and/or the like. A user may have an incentive to resell the card from its own location (i.e., to another customer), as the profit margin will be higher.

Step 304 may include the assessment of several criteria, including local popularity of the brand on the card, volatility of the card (susceptibility to fraud, devaluing), the commission charged by online vendors for that brand, how quickly the brand can be resold, and/or the like. If no clear answer comes from this analysis, the system may determine which option will have the best return on investment (ROI). ROI may be based on past transaction data, either for the specific business or across businesses.

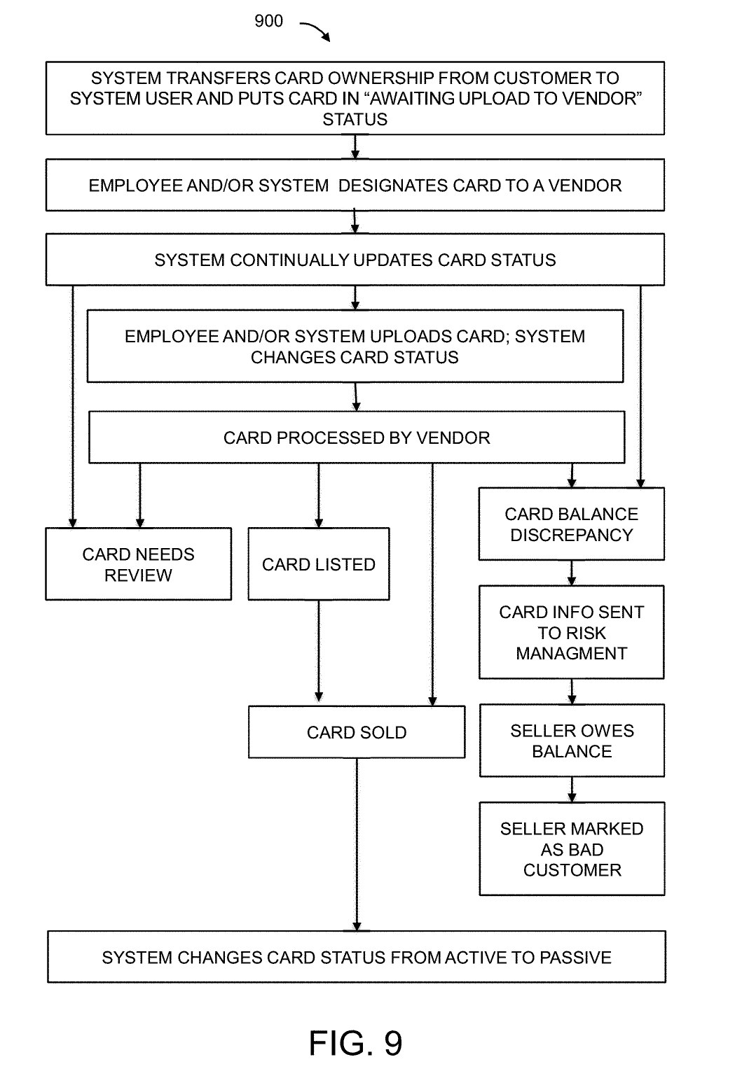

Following this analysis, the user may sell the card to a vendor at step 306. An illustrative method embodying step 306, including related steps and additional details, is included in FIG. 9 and generally indicated at 900.

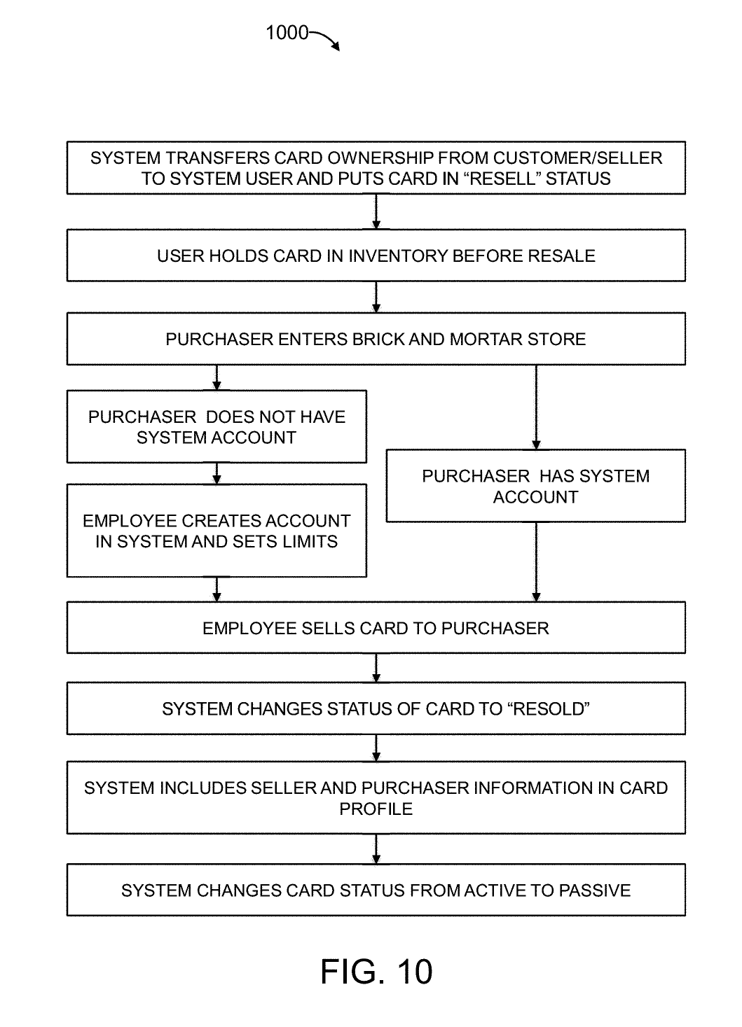

Alternatively, the user may resell the card to a second individual customer (e.g., customer B), from the user's own business or physical location, in step 308. In some examples, this may include holding the card for a predetermined amount of time (e.g., a week) before again verifying that the balance is accurate and then placing the card up for sale at a profit to the business. An illustrative method embodying step 308, including related steps and additional details, is included in FIG. 10 and generally indicated at 1000.

Alternatively, the user may sell the card on a network affiliated with the system and/or with the user's business, in step 310. By linking some or all of the businesses 106 that are utilizing system 100, an affiliate network may be created. Users can list their cards for sale on a marketplace (e.g., hosted by the overall system provider) that is specifically designed for those users. In effect, a master vendor site may be created that will directly integrate with system 100. Cards designated to be sold on the affiliate network may be sent to the marketplace site (e.g., instantaneously) after the purchase transaction is complete. The user may list, sell, and handle any discrepancies themselves through system 100. In return, certain benefits may be provided, e.g., cheaper commission rates and a quicker turnaround time from purchase to repayment on investment.

### D. Second Illustrative Method of Use

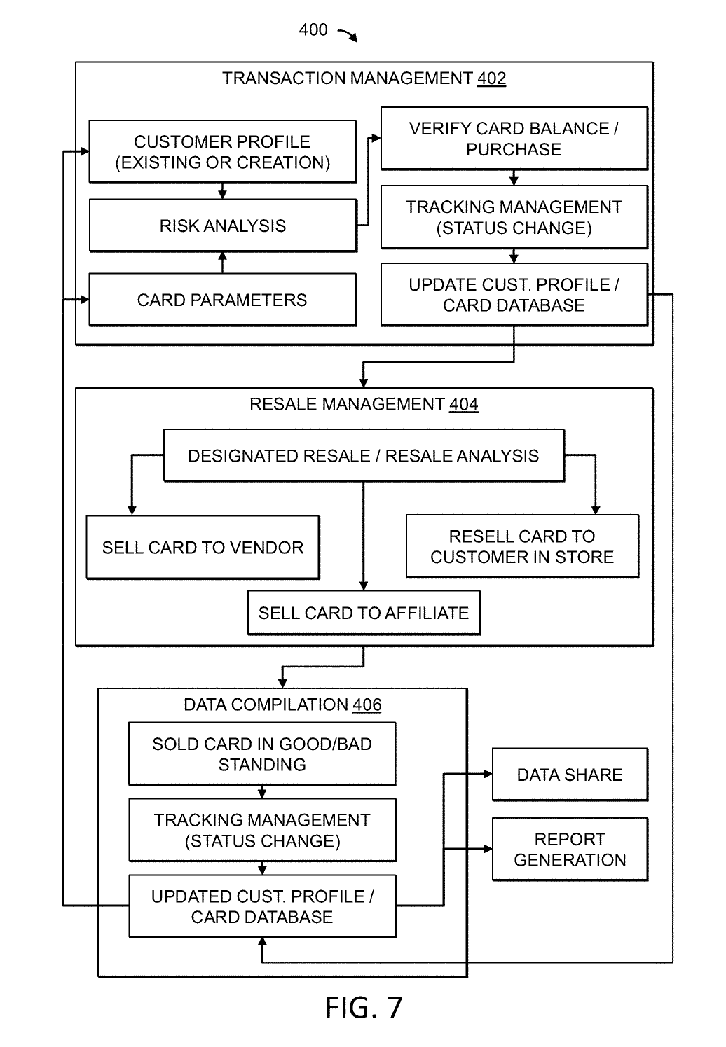

This section describes steps of an illustrative method 400 for using a gift card management system (e.g., system 100); see FIGS. 7-10. Aspects of gift card management systems described above may be utilized in the method steps described below. Where appropriate, reference may be made to previously described components and systems that may be used in carrying out each step. These references are for illustration, and are not intended to limit the possible ways of carrying out any particular step of the method.

FIG. 7 is a flowchart illustrating steps performed in an illustrative method, and may not recite the complete process or all steps of the method. FIG. 7 depicts multiple steps of a method, generally indicated at 400, which may be performed in conjunction with gift card management systems according to aspects of the present disclosure. Although various steps of method 400 are described below and depicted in FIG. 7, the steps need not necessarily all be performed, and in some cases may be performed in a different order than the order shown.

In this example, a transaction management phase 402 begins with a customer wishing to sell a gift card(s) to an establishment with a gift card management system. If the individual is an existing customer to the establishment or network associated with the establishment, and in good standing (e.g., has no debts from devalued cards), the existing customer profile will be populated and a new transaction will begin. If the individual is an existing customer to the establishment or network associated with the establishment and owes a debt (e.g., devalued card(s) after selling to the establishment), a new transaction will not continue. A user with manager/owner privileges will need to enter an override code to continue the transaction. If the individual is a new customer, a customer profile will be created.

The cards offered for purchase will be entered into the system and the card parameters feature will initially limit/stop any card from being purchased if a user defined limitation is reached. These limits include accepted brands, min value limit, and max value limit. If a limit is reached, a manager may override to continue the transaction. The percentage of payout for face value of the card will be displayed and aggregated for a multiple card transaction.

A risk analysis feature may include the use of algorithms (if selected) in conjunction with past customer transaction data and a risk level ranking (based on network data) for each card offered for purchase. A filtering algorithm may stop the transaction if the risk level ranking of the card is above a user-defined or user-selected limit (and if algorithm stoppage is selected). In some examples, a manager may be granted the ability to override this stoppage (e.g., with an authorization code or the like). See above for further discussion of illustrative risk management algorithms.

The card(s) offered for sale will be verified as having a balance with the associated merchant's website and the transaction will be completed. A user specific purchase agreement/contract will be printed upon completion and signed by the selling party.

The recently purchased cards will change status through tracking management and progress to the resale management phase. The selling customer's profile will be updated at this point.

An embodiment of the transaction management and/or purchasing process, including related steps and additional details, is included in FIG. 8 and generally indicated at 800.

A resale management phase 404 may include analyzing how the user/business should resell the card. Choices may include selling the card online to a third-party vendor (e.g., raise.com), selling the card on an affiliate network of gift card management users, or selling the card to another customer directly from the user/business. This analysis step may be performed by or with the assistance of the card management program. Analysis may include the assessment and weighing of factors such as card or vendor volatility, resale value, popularity, card features such as a scratch-off PIN, and/or the like. A user/business may have an incentive to resell the card from its own location (e.g., to another customer), as the profit margin will be higher.

Resale analysis may include the assessment of several criteria, including local popularity of the brand on the card, volatility of the card (susceptibility to fraud, devaluing), the commission charged by online vendors for that brand, how quickly the brand can be resold, and/or the like. If no clear answer comes from this analysis, the system may determine which option will have the best return on investment (ROI). ROI may be based on past transaction data or known commission/repayment rates, either for the specific business or across businesses.

Following this analysis, the user may sell the card to a vendor. An embodiment of this step, including related steps and additional details, is included in FIG. 9 and generally indicated at 900.

Alternatively, the user may sell the card to a second individual customer (e.g., customer B), from the user's own business or physical location. In some examples, this may include holding the card for a predetermined amount of time (e.g., a week) before again verifying that the balance is accurate and then placing the card up for sale at a profit to the business. An embodiment of this step, including related steps and additional details, is included in FIG. 10 and generally indicated at 1000.

Alternatively, the user may sell the card on a network affiliated with the system and/or with the user's business. By linking some or all of the businesses 106 that are utilizing system 100, an affiliate network may be created. Users can list their cards for sale on a marketplace (e.g., hosted by the overall system provider) that is specifically designed for those users. In effect, a master vendor site may be created that will directly integrate with system 100. Cards designated to be sold on the affiliate network may be sent to the marketplace site (e.g., instantaneously) after the purchase transaction is complete. The user may list, sell, and handle any discrepancies themselves through system 100. In return, certain benefits may be provided, e.g., cheaper commission rates and a quicker turnaround time from purchase to repayment on investment.

In a data compilation phase 406, the successfully sold card is categorized in good standing. Tracking management changes and archives the status to the final state of “sold,” and the customer profile is updated. This final status can be changed based on vendor/affiliate network/storefront customer refund policies. If the balance is devalued when the purchasing customer attempts to redeem the card, the customer will normally receive a refund and the vendor/affiliate network/storefront will notify the selling entity and redact payment for the sold card. Upon notification, the user will update the card profile as having a balance discrepancy and corresponding customer profile as owing a balance. This balance discrepancy card will be compiled for future card specific risk analysis and the customer who sold the card will be flagged for bad standing.

A data share module may pull card- and customer-specific information from data compilation (e.g., from the data store) for use by third parties, such as retailers and law enforcement. Report generation may pull information from data compilation for various reports. Reports such as return on investment and loss rate can be used to refine the card parameters feature (individual card limitations) to optimize profit and minimize loss rate.

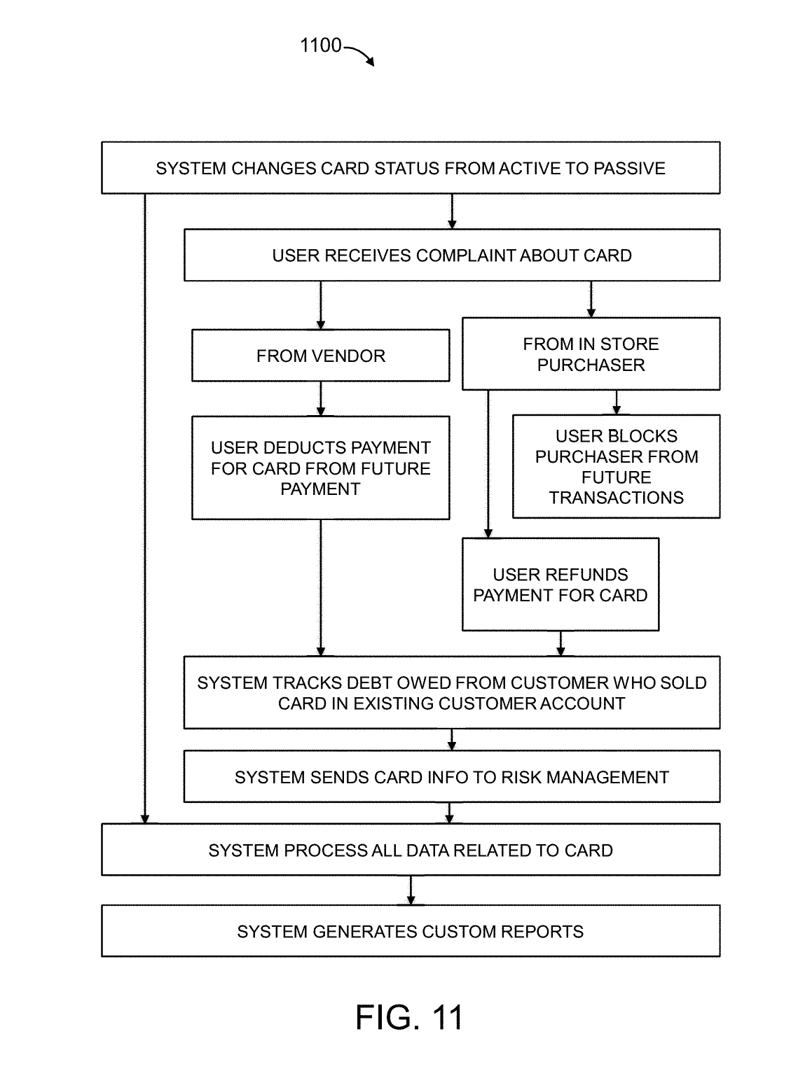

An illustrative method embodying aspects of phase 406, including related steps and additional details, is included in FIG. 11 and generally indicated at 1100.

### E. Illustrative Data Processing System

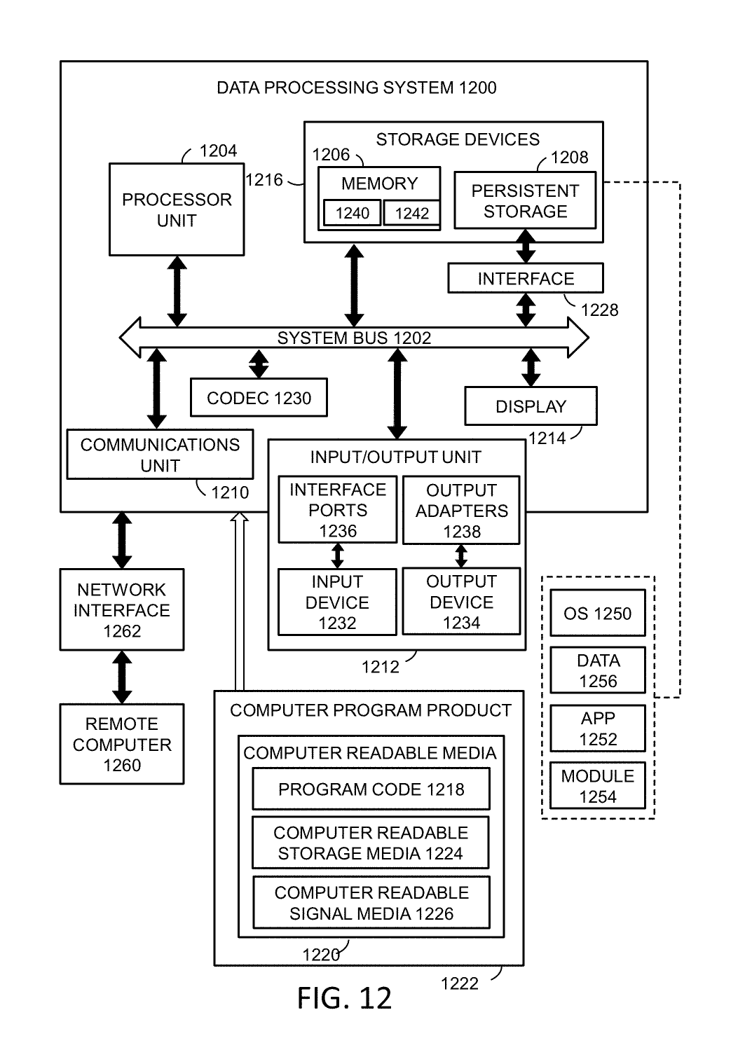

As shown in FIG. 12, this example describes a data processing system 1200 (also referred to as a computer) in accordance with aspects of the present disclosure. In this example, data processing system 1200 is an illustrative data processing system suitable for implementing aspects of gift card management systems. More specifically, in some examples, devices that are embodiments of data processing systems (e.g., smartphones, tablets, personal computers) may be utilized to run aspects of the card management program (e.g., as in data processing system 104 and program 102).

In this illustrative example, data processing system 1200 includes a system bus 1202 (also referred to as communications framework). System bus 1202 may provide communications between a processor unit 1204 (also referred to as a processor or processors), a memory 1206, a persistent storage 1208, a communications unit 1210, an input/output (I/O) unit 1212, a codec 1230, and/or a display 1214. Memory 1206, persistent storage 1208, communications unit 1210, input/output (I/O) unit 1212, display 1214, and codec 1230 are examples of resources that may be accessible by processor unit 1204 via system bus 1202.

Processor unit 1204 serves to run instructions that may be loaded into memory 1206. Processor unit 1204 may comprise a number of processors, a multi-processor core, and/or a particular type of processor or processors (e.g., a central processing unit (CPU), graphics processing unit (GPU), etc.), depending on the particular implementation. Further, processor unit 1204 may be implemented using a number of heterogeneous processor systems in which a main processor is present with secondary processors on a single chip. As another illustrative example, processor unit 1204 may be a symmetric multi-processor system containing multiple processors of the same type.

Memory 1206 and persistent storage 1208 are examples of storage devices 1216. A storage device may include any suitable hardware capable of storing information (e.g., digital information), such as data, program code in functional form, and/or other suitable information, either on a temporary basis or a permanent basis.

Storage devices 1216 also may be referred to as computer-readable storage devices or computer-readable media. Memory 1206 may include a volatile storage memory 1240 and a non-volatile memory 1242. In some examples, a basic input/output system (BIOS), containing the basic routines to transfer information between elements within the data processing system 1200, such as during start-up, may be stored in non-volatile memory 1242. Persistent storage 1208 may take various forms, depending on the particular implementation.

Persistent storage 1208 may contain one or more components or devices. For example, persistent storage 1208 may include one or more devices such as a magnetic disk drive (also referred to as a hard disk drive or HDD), solid state disk (SSD), floppy disk drive, tape drive, Jaz drive, Zip drive, LS-120 drive, flash memory card, memory stick, and/or the like, or any combination of these. One or more of these devices may be removable and/or portable, e.g., a removable hard drive. Persistent storage 1208 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 1208 to system bus 1202, a removable or non-removable interface is typically used, such as interface 1228.

Input/output (I/O) unit 1212 allows for input and output of data with other devices that may be connected to data processing system 1200 (i.e., input devices and output devices). For example, input device 1232 may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 1204 through system bus 1202 via interface port(s) 1236. Interface port(s) 1236 may include, for example, a serial port, a parallel port, a game port, and/or a universal serial bus (USB).

Output devices 1234 may use some of the same types of ports, and in some cases the same actual ports, as input device(s) 1232. For example, a USB port may be used to provide input to data processing system 1200 and to output information from data processing system 1200 to an output device 1234. Output adapter 1238 is provided to illustrate that there are some output devices 1234 (e.g., monitors, speakers, and printers, among others) which require special adapters. Output adapters 1238 may include, e.g. video and sounds cards that provide a means of connection between the output device 1234 and system bus 1202. Other devices and/or systems of devices may provide both input and output capabilities, such as remote computer(s) 1260. Display 1214 may include any suitable human-machine interface or other mechanism configured to display information to a user, e.g., a CRT, LED, or LCD monitor or screen, etc.

Communications unit 1210 refers to any suitable hardware and/or software employed to provide for communications with other data processing systems or devices. While communication unit 1210 is shown inside data processing system 1200, it may in some examples be at least partially external to data processing system 1200. Communications unit 1210 may include internal and external technologies, e.g., modems (including regular telephone grade modems, cable modems, and DSL modems), ISDN adapters, and/or wired and wireless Ethernet cards, hubs, routers, etc. Data processing system 1200 may operate in a networked environment, using logical connections to one or more remote computers 1260. A remote computer(s) 1260 may include a personal computer (PC), a server, a router, a network PC, a workstation, a microprocessor-based appliance, a peer device, a smart phone, a tablet, another network note, and/or the like. Remote computer(s) 1260 typically include many of the elements described relative to data processing system 1200. Remote computer(s) 1260 may be logically connected to data processing system 1200 through a network interface 1262 which is connected to data processing system 1200 via communications unit 1210. Network interface 1262 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 1230 may include an encoder, a decoder, or both, comprising hardware, software, or a combination of hardware and software. Codec 1230 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 1230 is depicted as a separate component, codec 1230 may be contained or implemented in memory, e.g., non-volatile memory 1242.

Non-volatile memory 1242 may include read only memory (ROM), programmable ROM (PROM), electrically programmable ROM (EPROM), electrically erasable programmable ROM (EEPROM), flash memory, and/or the like, or any combination of these. Volatile memory 1240 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 1216, which are in communication with processor unit 1204 through system bus 1202. In these illustrative examples, the instructions are in a functional form in persistent storage 1208. These instructions may be loaded into memory 1206 for execution by processor unit 1204. Processes of one or more embodiments of the present disclosure may be performed by processor unit 1204 using computer-implemented instructions, which may be located in a memory, such as memory 1206.

These instructions are referred to as program instructions, program code, computer usable program code, or computer-readable program code executed by a processor in processor unit 1204. The program code in the different embodiments may be embodied on different physical or computer-readable storage media, such as memory 1206 or persistent storage 1208. Program code 1218 may be located in a functional form on computer-readable media 1220 that is selectively removable and may be loaded onto or transferred to data processing system 1200 for execution by processor unit 1204. Program code 1218 and computer-readable media 1220 form computer program product 1222 in these examples. In one example, computer-readable media 1220 may comprise computer-readable storage media 1224 or computer-readable signal media 1226.

Computer-readable storage media 1224 may include, for example, an optical or magnetic disk that is inserted or placed into a drive or other device that is part of persistent storage 1208 for transfer onto a storage device, such as a hard drive, that is part of persistent storage 1208. Computer-readable storage media 1224 also may take the form of a persistent storage, such as a hard drive, a thumb drive, or a flash memory, that is connected to data processing system 1200. In some instances, computer-readable storage media 1224 may not be removable from data processing system 1200.

In these examples, computer-readable storage media 1224 is a physical or tangible storage device used to store program code 1218 rather than a medium that propagates or transmits program code 1218. Computer-readable storage media 1224 is also referred to as a computer-readable tangible storage device or a computer-readable physical storage device. In other words, computer-readable storage media 1224 is media that can be touched by a person.

Alternatively, program code 1218 may be transferred to data processing system 1200, e.g., remotely over a network, using computer-readable signal media 1226. Computer-readable signal media 1226 may be, for example, a propagated data signal containing program code 1218. For example, computer-readable signal media 1226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 1218 may be downloaded over a network to persistent storage 1208 from another device or data processing system through computer-readable signal media 1226 for use within data processing system 1200. For instance, program code stored in a computer-readable storage medium in a server data processing system may be downloaded over a network from the server to data processing system 1200. The computer providing program code 1218 may be a server computer, a client computer, or some other device capable of storing and transmitting program code 1218.

In some examples, program code 18 may comprise be an operating system (OS) 1250. Operating system 1250, which may be stored on persistent storage 1208, controls and allocates resources of data processing system 1200. One or more applications 1252 take advantage of the operating system's management of resources via program modules 1254, and program data 1256 stored on storage devices 1216. OS 1250 may include any suitable software system configured to manage and expose hardware resources of computer 1200 for sharing and use by applications 1252. In some examples, OS 1250 provides application programming interfaces (APIs) that facilitate connection of different type of hardware and/or provide applications 1252 access to hardware and OS services. In some examples, certain applications 1252 may provide further services for use by other applications 1252, e.g., as is the case with so-called “middleware.” Aspects of present disclosure may be implemented with respect to various operating systems or combinations of operating systems.

The different components illustrated for data processing system 1200 are not meant to provide architectural limitations to the manner in which different embodiments may be implemented. One or more embodiments of the present disclosure may be implemented in a data processing system that includes fewer components or includes components in addition to and/or in place of those illustrated for computer 1200. Other components shown in FIG. 12 can be varied from the examples depicted. Different embodiments may be implemented using any hardware device or system capable of running program code. As one example, data processing system 1200 may include organic components integrated with inorganic components and/or may be comprised entirely of organic components (excluding a human being). For example, a storage device may be comprised of an organic semiconductor.

In some examples, processor unit 1204 may take the form of a hardware unit having hardware circuits that are specifically manufactured or configured for a particular use, or to produce a particular outcome or progress. This type of hardware may perform operations without needing program code 1218 to be loaded into a memory from a storage device to be configured to perform the operations. For example, processor unit 1204 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 1218) may be implemented as hardware, e.g., by specifying an FPGA configuration using a hardware description language (HDL) and then using a resulting binary file to (re)configure the FPGA.

In another example, data processing system 800 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 1204 may be implemented using a combination of processors found in computers and hardware units. Processor unit 1204 may have a number of hardware units and a number of processors that are configured to run program code 1218. With this depicted example, some of the processes may be implemented in the number of hardware units, while other processes may be implemented in the number of processors.

In another example, system bus 1202 may comprise one or more buses, such as a system bus or an input/output bus. Of course, the bus system may be implemented using any suitable type of architecture that provides for a transfer of data between different components or devices attached to the bus system. System bus 1202 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 1210 may include a number of devices that transmit data, receive data, or both transmit and receive data. Communications unit 1210 may be, for example, a modem or a network adapter, two network adapters, or some combination thereof. Further, a memory may be, for example, memory 1206, or a cache, such as that found in an interface and memory controller hub that may be present in system bus 1202.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

### F. Illustrative Distributed Data Processing System

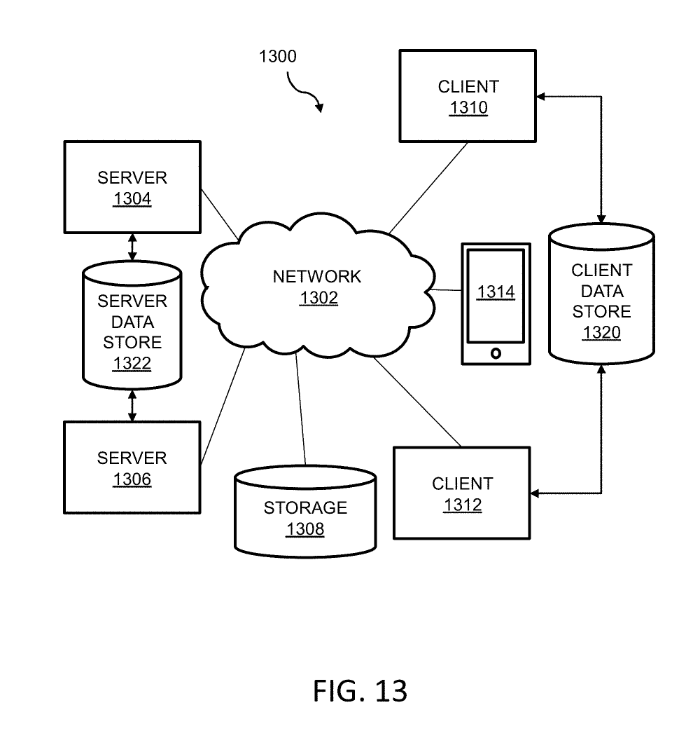

As shown in FIG. 13, this example describes a general network data processing system 1300, interchangeably termed a computer network, a network system, a distributed data processing system, or a distributed network, aspects of which may be included in one or more illustrative embodiments of the card management systems described herein. For example, see the discussion of network 118 with respect to FIG. 1. In some examples, some or all of the card management program may be implemented on a network, such that components or modules or data stores may be located on different computers or servers in communication with each other over the network.

It should be appreciated that FIG. 13 is provided as an illustration of one implementation and is not intended to imply any limitation with regard to environments in which different embodiments may be implemented. Many modifications to the depicted environment may be made.

Network system 1300 is a network of devices (e.g., computers), each of which may be an example of data processing system 1200, and other components. Network data processing system 1300 may include network 1302, which is a medium configured to provide communications links between various devices and computers connected within network data processing system 1300. Network 1302 may include connections such as wired or wireless communication links, fiber optic cables, and/or any other suitable medium for transmitting and/or communicating data between network devices, or any combination thereof.

In the depicted example, a first network device 1304 and a second network device 1306 connect to network 1302, as do one or more computer-readable memories or storage devices 1308. Network devices 1304 and 1306 are each examples of data processing system 1200, described above. In the depicted example, devices 1304 and 1306 are shown as server computers, which are in communication with one or more server data store(s) 1322 that may be employed to store information local to server computers 1304 and 1306, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 1310 and 1312 and/or a client smart device 1314, may connect to network 1302. Each of these devices is an example of data processing system 1200, described above regarding FIG. 12. Client electronic devices 1310, 1312, and 1314 may include, for example, one or more personal computers, network computers, and/or mobile computing devices such as personal digital assistants (PDAs), smart phones, handheld gaming devices, wearable devices, and/or tablet computers, and the like. In the depicted example, server 1304 provides information, such as boot files, operating system images, and applications to one or more of client electronic devices 1310, 1312, and 1314. Client electronic devices 1310, 1312, and 1314 may be referred to as “clients” in the context of their relationship to a server such as server computer 1304. Client devices may be in communication with one or more client data store(s) 1320, which may be employed to store information local to the clients (e,g., cookie(s) and/or associated contextual information). Network data processing system 1300 may include more or fewer servers and/or clients (or no servers or clients), as well as other devices not shown.

In some examples, first client electric device 1310 may transfer an encoded file to server 1304. Server 1304 can store the file, decode the file, and/or transmit the file to second client electric device 1312. In some examples, first client electric device 1310 may transfer an uncompressed file to server 1304 and server 1304 may compress the file. In some examples, server 1304 may encode text, audio, and/or video information, and transmit the information via network 1302 to one or more clients.

Client smart device 1314 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 1300 may be stored in or on a computer-readable storage medium, such as network-connected storage device 1308 and/or a persistent storage 1208 of one of the network computers, as described above, and may be downloaded to a data processing system or other device for use. For example, program code may be stored on a computer-readable storage medium on server computer 1304 and downloaded to client 1310 over network 1302, for use on client 1310. In some examples, client data store 1320 and server data store 1322 reside on one or more storage devices 1308 and/or 1208.

Network data processing system 1300 may be implemented as one or more of different types of networks. For example, system 1300 may include an intranet, a local area network (LAN), a wide area network (WAN), or a personal area network (PAN). In some examples, network data processing system 1300 includes the Internet, with network 1302 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 1302 may be referred to as a “cloud.” In those examples, each server 1304 may be referred to as a cloud computing node, and client electronic devices may be referred to as cloud consumers, or the like. FIG. 13 is intended as an example, and not as an architectural limitation for any illustrative embodiments.

### G. Additional Examples and Illustrative Combinations

This section describes additional aspects and features of gift card management systems, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A gift card management system comprising:

one or more processors;

a memory;

a plurality of instructions stored in the memory and executable by the one or more processors to:
receive and store information relating to a gift card, the information including brand identifier, monetary value, and selling customer;
present a user, via a user interface, with information relating to a transaction history of the selling customer;
in response to a first user input, record a transaction including a purchase of the gift card by the user from the selling customer;
assign a first status to the gift card;
in response to a second user input, list the gift card for sale and assign a second status to the gift card;
in response to a third user input, flag the gift card as failed due to devaluation after purchase, and assign a third status to the gift card;
in response to a fourth user input, transfer ownership of the gift card to a resale purchaser, and assign a fourth status to the gift card;
interface with a data store to aggregate data relating to the purchase and sale of the gift card with data from other transactions regarding other gift cards.

A1. The system of A0, wherein the plurality of instructions are further executable by the one or more processors to:

in response to a failure to proceed from the second status to either the third or the fourth status after a selected time period, alert the user of a lack of progress.

A2. The system of A0, further comprising a reader device in communication with the card management system, wherein receiving and storing information relating to the gift card comprises using the reader device to automatically read the information on the gift card.

A3. The system of A2, wherein the reader device comprises a digital camera configured to perform image recognition on the gift card.

A4. The system of A0, wherein the plurality of instructions are further executable by the one or more processors to generate reports based on the aggregated data.

A5. The system of A0, wherein the gift card management system is implemented in a computer network, and data is aggregated across the network to include a plurality of users, customers, and transactions.

B0. A computer-implemented method for displaying risk information relating to and facilitating the purchase of one or more gift cards, the method comprising:

receiving, via a graphical user interface (GUI) of a computer-implemented gift card management system, entered information relating to a gift card being presented from a customer for purchase by a user, the entered information comprising a brand identifier and a monetary value; and

in response to receiving the brand identifier and the monetary value, dynamically displaying a risk level indicator via the GUI on a same screen as the entered information, the risk level indicator corresponding to an estimated probability of failure of the gift card being purchased;

wherein the risk level indicator represents a risk level based on a combination of factors comprising a first factor corresponding to historical failure data related to the brand identifier and a second factor corresponding to historical failure data related to the monetary value, the factors being weighted by respective coefficients selected by the user.

B1. The method of B0, further comprising, in response to the risk level failing to comply with a selected limit, automatically preventing the purchase of the gift card.

B2. The method of B0, wherein the combination of factors further comprises a third factor corresponding to a risk value associated with the customer.

B3. The method of B2, wherein the risk value associated with the customer corresponds to a number of successful previous transactions between the customer and the user.

B4. The method of B0, wherein the combination of factors further comprises a fourth factor corresponding to historical failure data related to the monetary value of cards having the entered brand identifier.

B5. The method of B0, wherein the historical failure data related to the brand identifier and the monetary value is aggregated from a plurality gift card management systems.

B6. The method of B5, wherein the plurality of gift card management systems are in communication over a computer network.

B7. The method of B0, wherein a sum of the selected coefficients is required to equal a selected total.

B8. The method of B0, wherein each of the selected coefficients is limited to a selected range.

B9. The method of B0, wherein the risk level indicator comprises a risk category.

C0. A computer-implemented method for reselling a gift card, the method comprising:

receiving, by a computer-implemented gift card management system, an entered first set of information relating to a gift card being presented from a customer for purchase by a user, the first set of information including a brand identifier and a monetary value;

retrieving, from a data store of the system, a second set of information relating to a plurality of gift card-purchasing vendors and a third set of information relating to a gift card resale market;

based on the first, second, and third sets of information, calculating a return on investment (ROI) for each of the plurality of vendors;

determining which vendor of the plurality of vendors has a largest ROI, and identifying the vendor with the largest ROI as a preferred resale vendor;

dynamically notifying the user, via the gift card management system, of the preferred resale vendor; and

in response to at least one command received via the gift card management system, listing the first gift card for sale with the preferred resale vendor.

C1. The method of C0, wherein the plurality of gift card-purchasing vendors comprises one or more other customers of the user.

C2. The method of C0, further comprising, in response to the gift card being listed for sale for greater than a selected time period, alerting the user to a lack of progress.

C3. The method of C0, further comprising: in response to a failure of the gift card due to devaluation after ownership transferred to the user, updating a customer history of the selling customer to reflect the failure.

D. A gift card management system having an automated and/or linked balance-checker, such that the user does not have to go to a merchant website to check a card's balance.

E. A gift card management system having a digital image of the card attached to the card profile.

F. A gift card management system, in which customer data is retained and tracked for all businesses subscribing to the SaaS program. Information may be shared with other users, merchants, retail agencies, government agencies, and the like, e.g., for fraud mitigation, marketing, and regulatory reasons.

G. A gift card management system may comprise a mobile app.

H. A gift card management system that will transmit card data to the vendor of choice in real time (right after purchase is executed) rather than manually batching the cards (one at a time or in bulk) each day (or weekly) to vendor. This ensures quick repayment on initial investment.

I. The system may include a maximum profit algorithm which, when directly integrated with vendors or using historical sale data, allows the system to continually search for the highest rate of return (including comparing marketplace and storefront resale options). The system then suggests a resale location for individual cards.

J. The system may include a loss alert system. The loss alert system continually searches for users with above average loss rates. When the loss alert system finds an above average loss rate, a system provider (e.g., SaaS provider or multi-location user) is alerted to assist the user.

K. The system may include a bulk upload/download feature that allows features or information to be uploaded or downloaded in bulk.

L. The system may include a reselling timeline feature which helps the user to ensure that an individual card is only listed on the marketplace or for sale in the storefront for a designated time before, e.g., delisting the card and relisting it with a different vendor.

M. The system may include a payout dictation algorithm. The algorithm determines the percentage of the card's value that the user should pay to the customer based on the ROI of an individual card and/or its failure rate. For a card that, based on its brand, type, or value, historically has a smaller profit margin than other cards (due to a lower ROI or a higher failure rate), the payout dictation algorithm may suggest a smaller payout factor.

N. The system may include a “lack of status progression” feature. When a card does not progress to a new status (the exception is cards that have been sold), after a selected amount of time, the card may be given a “Status Progression Error” status (or the like).

### Advantages, Features, Benefits

The different embodiments and examples of the gift card management systems described herein provide several advantages over known solutions for purchasing and selling gift cards in the resale market. For example, illustrative embodiments and examples described herein allow resale and end to end (e.g., cradle to grave) tracking of gift card transactions among multiple resale vendors, network affiliates, and/or storefront resale.

Additionally, and among other benefits, illustrative embodiments and examples described herein facilitate automatic and manual risk management, risk assessment, and risk level adjustment with respect to customers, cards, and/or merchants.

Additionally, and among other benefits, illustrative embodiments and examples described herein provide a way to accurately set customer limits (max value or card limits) either per transaction, daily, weekly, monthly (30 day rolling cycle), or yearly.

Additionally, and among other benefits, illustrative embodiments and examples described herein provide a way to set fixed brand-specific card payout percentages based on card value.

Additionally, and among other benefits, illustrative embodiments and examples described herein provide a way to accurately determine profit, loss, ROI, etc., using either a single or multiple vendors.

Additionally, and among other benefits, illustrative embodiments and examples described herein enable the user to resell cards directly through a brick and mortar application. Both the selling and purchasing customers will be linked to the card profile.

Additionally, and among other benefits, illustrative embodiments and examples described herein enable a brick and mortar location to offer cards for sale either from the establishment's own purchased inventory or from an online vendor's or affiliated network (fellow subscribers) inventory, or partnered vendors that wish to sell cards through the system.

Additionally, and among other benefits, illustrative embodiments and examples described herein enable the system user to use an algorithm to identify in real time or near real time the highest rate of return among multiple resell venues and execute a resell transaction.

No known system or device can perform these functions. However, not all embodiments and examples described herein provide the same advantages or the same degree of advantage.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A gift card management system comprising:
one or more processors;
a memory;
a plurality of instructions stored in the memory and executable by the one or more processors to:
receive and store information relating to a gift card, the information including brand identifier, monetary value, and selling customer;
present a user, via a user interface, with information relating to a transaction history of the selling customer;
in response to a first user input, record a transaction including a purchase of the gift card by the user from the selling customer;
assign a first status to the gift card;
in response to a second user input, list the gift card for sale and assign a second status to the gift card;
in response to a third user input, flag the gift card as failed due to devaluation after purchase, and assign a third status to the gift card;
in response to a fourth user input, transfer ownership of the gift card to a resale purchaser, and assign a fourth status to the gift card;
interface with a data store to aggregate data relating to the purchase and sale of the gift card with data from other transactions regarding other gift cards.

2. The system of claim 1, wherein the plurality of instructions are further executable by the one or more processors to:
in response to a failure to proceed from the second status to either the third or the fourth status after a selected time period, alert the user of a lack of progress.

3. The system of claim 1, further comprising a reader device in communication with the card management system, wherein receiving and storing information relating to the gift card comprises using the reader device to automatically read the information on the gift card.

4. The system of claim 3, wherein the reader device comprises a digital camera configured to perform image recognition on the gift card.

5. The system of claim 1, wherein the plurality of instructions are further executable by the one or more processors to generate reports based on the aggregated data.

6. The system of claim 1, wherein the gift card management system is implemented in a computer network, and data is aggregated across the network to include a plurality of users, customers, and transactions.

7. A computer-implemented method for displaying risk information relating to and facilitating the purchase of one or more gift cards, the method comprising:
receiving, via a graphical user interface (GUI) of a computer-implemented gift card management system, entered information relating to a gift card being presented from a customer for purchase by a user, the entered information comprising a brand identifier and a monetary value; and
in response to receiving the brand identifier and the monetary value, dynamically displaying a risk level indicator via the GUI on a same screen as the entered information, the risk level indicator corresponding to an estimated probability of failure of the gift card being purchased;
wherein the risk level indicator represents a risk level based on a combination of factors comprising a first factor corresponding to historical failure data related to the brand identifier and a second factor corresponding to historical failure data related to the monetary value, the factors being weighted by respective coefficients selected by the user.

8. The method of claim 7, further comprising, in response to the risk level failing to comply with a selected limit, automatically preventing the purchase of the gift card.

9. The method of claim 7, wherein the combination of factors further comprises a third factor corresponding to a risk value associated with the customer.

10. The method of 9, wherein the risk value associated with the customer corresponds to a number of successful previous transactions between the customer and the user.

11. The method of claim 7, wherein the combination of factors further comprises a fourth factor corresponding to historical failure data related to the monetary value of cards having the entered brand identifier.

12. The method of claim 7, wherein the historical failure data related to the brand identifier and the monetary value is aggregated from a plurality gift card management systems.

13. The method of claim 12, wherein the plurality of gift card management systems are in communication over a computer network.

14. The method of claim 7, wherein a sum of the selected coefficients is required to equal a selected total.

15. The method of claim 7, wherein each of the selected coefficients is limited to a selected range.

16. The method of claim 7, wherein the risk level indicator comprises a risk category.

17. A computer-implemented method for reselling a gift card, the method comprising:
receiving, by a computer-implemented gift card management system, an entered first set of information relating to a gift card being presented from a selling customer for purchase by a user, the first set of information including a brand identifier and a monetary value;
retrieving, from a data store of the system, a second set of information relating to a plurality of gift card-purchasing vendors and a third set of information relating to a gift card resale market;
based on the first, second, and third sets of information, calculating a return on investment (ROI) for each of the plurality of vendors;
determining which vendor of the plurality of vendors has a largest ROI, and identifying the vendor with the largest ROI as a preferred vendor;
dynamically notifying the user, via the gift card management system, of the preferred vendor; and
in response to at least one command received via the gift card management system, transferring ownership of the card to the user and listing the gift card for sale with the preferred vendor.

18. The method of claim 17, wherein the plurality of gift card-purchasing vendors comprises one or more other customers of the user.

19. The method of claim 17, further comprising, in response to the gift card being listed for sale for greater than a selected time period, alerting the user to a lack of progress.

20. The method of claim 17, further comprising: in response to a failure of the gift card due to devaluation after ownership transferred to the user, updating a customer history of the selling customer to reflect the failure.
